(19) United States
(12) Patent Application Publication
(10) Pub. No.: US 2026/0087981 A1
(43) Pub. Date: Mar. 26, 2026

(54) DISPLAY APPARATUS

(71) Applicant: LG Display Co., Ltd., Seoul (KR)

(72) Inventors: Cheolsu LEE, Paju-si (KR); Hyungseok SEO, Paju-si (KR)

(73) Assignee: LG Display Co., Ltd., Seoul (KR)

(21) Appl. No.: 19/086,744

(22) Filed: Mar. 21, 2025

(30) Foreign Application Priority Data
Sep. 24, 2024 (KR) 10-2024-0128769

(51) Int. Cl. G09G 3/3233; G09G 3/20

(52) U.S. Cl. CPC G09G 3/3233; G09G 3/2074; G09G 2300/0842; G09G 2310/08; G09G 2320/046; G09G 2330/02

(57) ABSTRACT

The display apparatus according to the disclosure includes an EVSS transistor disposed between the EVSS node and the ground node and turned on and off by the power driving unit. With the control according to the present disclosure, the current path between the driving voltage line and the reference voltage line can be blocked, preventing burnout of the device. Furthermore, when the display apparatus is terminated by the BDP signal or naturally shut down, the control according to the disclosure allows the nodes of the driving transistor to be controlled to 0V and the residual voltage of the gate line to be controlled to 0V, thereby preventing a shift in the threshold voltage of the driving transistor during a long idle period.

### CROSS-REFERENCE TO RELATED APPLICATION

The present application claims priority to Korean Patent Application No. 10-2024-0128769, filed Sep. 24, 2024, the entire contents of which is incorporated herein for all purposes by this reference.

### BACKGROUND

### Technical Field

This disclosure relates to a display apparatus, and more particularly, to a display apparatus capable of preventing the burnout of elements within the display apparatus and preventing a threshold voltage shift phenomenon of a driving transistor even when the display panel is left idle for a long period of time.

### Description of the Related Art

The display apparatus can be integrated into electronic and home appliances such as televisions, monitors, laptop computers, smartphones, tablet computers, electronic pads, wearable devices, smartwatches, navigation systems, and vehicle control display devices, serving as a screen for image display.

In particular, an organic light-emitting display apparatus utilizes various voltages to emit light from organic light-emitting diodes. For example, these include a pixel driving voltage applied from an external set device as the high-potential level voltage of the organic light-emitting diode, a pixel base voltage as the low-potential level voltage of the organic light-emitting diode, a scan signal with a voltage level between a gate high voltage and a gate low voltage for driving a transistor, a data voltage output from a data driving unit, and a reference voltage.

### BRIEF SUMMARY

When various types of voltages input into the display apparatus are abnormal, problems such as element burnout (burnt) can occur. To address this, the display apparatus senses the input voltages and generates a burnt detection and protection (BDP) signal upon detecting an abnormal condition. This disclosure aims to provide a display apparatus capable of facilitating operation when a BDP signal is generated.

Meanwhile, it takes time for the display panel to be manufactured and delivered to the finished goods manufacturer. During this time, the levels of the voltages applied during the manufacturing of the display apparatus may change, leading to issues such as the threshold voltage shift phenomenon of the driving transistor. This disclosure aims to provide a display apparatus capable of preventing the threshold voltage shift phenomenon of the driving transistor.

A display apparatus according to the disclosure includes a sub-pixel connected to a driving voltage line, a data line, a reference line, and a gate line, and driven by a pixel driving voltage and a pixel base voltage, the sub-pixel including an organic light-emitting diode, a display panel including multiple sub-pixels arranged thereon, a data driving circuit configured to output a data voltage and a reference voltage to the display panel, a gate driving circuit configured to output a scan signal and a sensing signal to the display panel, a timing controller configured to output a plurality of timing control signals, a power driving circuit configured to output a plurality of voltages including a gate high voltage and a gate low voltage and output a BDP signal, generated during abnormal driving of the display panel, to the timing controller and an external set system, an EVSS transistor disposed between a pixel base voltage node and a ground node and controlled by an EVSS floating signal.

The EVSS transistor connects an EVSS node and the ground node when turned on, and blocks the connection between the EVSS node and the ground node when turned off.

The EVSS transistor is disposed on a control printed circuit board.

The power driving circuit receives an EVDD sensing signal configured to sense the pixel driving voltage and an EVSS sensing signal configured to sense the pixel base voltage.

The data driving circuit, based on the decrease in the pixel driving voltage, performs at least one of a turn-on discharge configured to output a data voltage and reference voltage for displaying the image of the last frame, and a turn-off discharge configured to output a data voltage and reference voltage for displaying an image with a 0 gray scale.

The power driving circuit outputs an EVSS floating signal to control the turn-on and turn-off of the EVSS transistor.

The timing controller blocks the output of the gate clock to perform a scan mask.

The data driving circuit performs a data output floating to block the output of the data voltage and reference voltage.

The timing controller outputs a data output floating signal through a data packet for the data output floating.

The power driving circuit performs zero-level control to output a voltage level of the gate low voltage as zero voltage after the turn-off of the display apparatus.

The display apparatus further include a first period and a second period during which the level of the pixel driving voltage is maintained after the BDP signal is generated.

During the first period, the timing controller limits the output of the gate clock, and the driving transistor of the sub-pixel is turned off.

During the second period, the EVSS transistor is turned off, and the driving voltage line is opened.

During the second period, the data driving circuit blocks the output of the data voltage and reference voltage, and the reference line is opened.

The display apparatus further includes a period A during which the level of the pixel driving voltage decreases after the BDP signal is generated, and a period B during which the pixel driving voltage decreases by a selected voltage level (or in some embodiments, a predetermined voltage level).

During the period A, the data driving circuit outputs a data voltage and reference voltage for displaying the image of the last frame, and the pixel driving voltage decreases at a first discharge rate, the slope of which is greater than that of the second discharge rate during natural discharge.

The sub-pixel includes a driving transistor, the third node of which is discharged to 0V.

The sub-pixel includes a driving transistor, and during the period B, the data driving circuit outputs a data voltage and reference voltage for displaying an image with a 0 gray scale, and the first node and second node of the driving transistor are discharged to 0V.

During the period B, the power driving circuit outputs the gate low voltage at the zero level.

The display apparatus further includes a period X during which the level of the pixel driving voltage decreases after the display apparatus is turned off, and a period Y during which the pixel driving voltage decreases by a selected voltage level (or in some embodiments, a predefined voltage level).

During the period X, the data driving circuit outputs a data voltage and reference voltage for displaying the image of the last frame, and the pixel driving voltage decreases at the first discharge rate, the slope of which is greater than that of the second discharge rate during natural discharge.

The sub-pixel includes a driving transistor, the third node of which is discharged to 0V.

The sub-pixel includes a driving transistor, and during the period Y, the data driving circuit outputs a data voltage and reference voltage for displaying an image with a 0 gray scale, and the first and second nodes of a driving transistor are discharged to 0V.

During the period Y, the power driving circuit outputs the gate low voltage at the zero level.

### BRIEF DESCRIPTION OF THE SEVERAL VIEWS OF THE DRAWINGS

FIG. 1 is a diagram illustrating a display apparatus according to this disclosure;

FIG. 2 is a perspective view illustrating a display apparatus according to this disclosure;

FIG. 3 is a diagram illustrating a sub-pixel according to this disclosure;

FIG. 4 is a timing diagram illustrating the signals applied to a timing controller;

FIG. 5 is a diagram illustrating the EPI communication between a timing controller and a data driving unit according to this disclosure;

FIG. 6 is a timing diagram illustrating EPI communication according to this disclosure;

FIG. 7 is a diagram illustrating a data driving unit according to this disclosure;

FIG. 8 is a circuit diagram illustrating the sensing of a driving transistor according to this disclosure;

FIG. 9 is a diagram illustrating the sensing sequence occurring at various timings according to this disclosure;

FIG. 10 is a diagram illustrating a gate driving unit according to this disclosure;

FIG. 11 is a diagram illustrating the stages of a gate driving unit according to this disclosure;

FIG. 12 is a diagram illustrating a scan mask according to this disclosure;

FIG. 13 is a diagram illustrating a display apparatus according to this disclosure;

FIG. 14 is a waveform diagram according to the first embodiment of this disclosure;

FIGS. 15 and 16 are diagrams illustrating the operational states of the display apparatus according to the first embodiment of this disclosure;

FIG. 17 is a waveform diagram according to the second embodiment of this disclosure;

FIG. 18 is a diagram illustrating the operational state of the display apparatus according to the second embodiment of this disclosure;

FIG. 19 is a waveform diagram according to a comparative example of this disclosure;

FIG. 20 is a waveform diagram according to the second embodiment; and

FIG. 21 is a waveform diagram according to a third embodiment of this disclosure.

### DETAILED DESCRIPTION

Advantages and features of the disclosure and methods of accomplishing the same may be understood more readily by reference to the following detailed description of embodiments and the accompanying drawings. The present disclosure may, however, be embodied in many different forms and should not be construed as being limited to the exemplary embodiments set forth herein; rather, these exemplary embodiments are provided so that the present disclosure will be thorough and complete and will fully convey the concept of the disclosure to those skilled in the art.

The shapes, sizes, ratios, angles, numbers and the like illustrated in the drawings to describe embodiments of the disclosure are merely exemplary, and thus, the disclosure is not limited thereto. Throughout the specification, the same reference numerals refer to the same components. In addition, detailed descriptions of well-known technologies may be omitted in the disclosure to avoid obscuring the subject matter of the disclosure. When terms such as “comprises,” “has,” “includes,” or “is made up of” are used in this specification, it should be understood that unless “only” is specifically used, additional elements or steps can be included. Unless otherwise explicitly stated, when a component is expressed in the singular form, it is intended to encompass the plural form as well.

In interpreting the components, it is construed to include a margin of error even in the absence of explicit description.

When describing the positional relationship, for example, when the relationship between two parts is described as “on,” “on top of,” “underneath,” “beside,” etc., unless “directly” or “immediately” is used, one or more other parts may be located between the two parts.

When a device or layer is referred to as being “on” another device or layer, it includes cases where one device or layer is directly located on the other device or layer or still other device or layer is interposed between the two devices or layers.

As used herein, the terms “connected” and “coupled” are intended to be interpreted with the broadest possible meaning. Specifically, the phrase “A is connected to B” encompasses both a direct connection between A and B-where no intervening components or elements are present as well as an indirect connection, where one or more intervening components or elements exist between A and B. Similarly, the term “coupled” should be understood in the same manner. For instance, “A is coupled to B” includes both a direct physical or electrical coupling and an indirect coupling facilitated through one or more intermediate components or elements. Unless expressly specified otherwise (e.g., “directly connected”), these terms do not imply or require direct physical contact.

Although the terms “first,” “second,” and the like are used to describe various components, these components are not limited by these terms. These terms are merely used for distinguishing one component from the other components. Therefore, the first component mentioned hereinafter may be the second component in the technical sense of the disclosure.

Throughout the specification, the same reference numerals refer to the same components.

The sizes and thicknesses of each component shown in the drawings are presented for the convenience of description and are not intended to limit the present disclosure.

The features of various embodiments of the present disclosure can be combined or assembled, either partially or entirely, in various technical manners such as interlocking and interoperations obvious to those skilled in the art, and each embodiment can be independently implemented or in conjunction with related embodiments.

Hereinafter, detailed descriptions are made of the embodiments of the present disclosure with reference to the accompanying drawings.

In this disclosure, the term “display apparatus” is used in a narrow sense to refer to display apparatuses, such as a liquid crystal module (LCM), an organic light-emitting diode (OLED) module, and a quantum dot (QD) module, each including a display panel and a panel driving unit to operate the display panel. In addition, the term may also be used to refer to set electronic devices, set devices, or apparatuses that include LCMs, OLED modules, QD modules, and the like, such as equipment display apparatuses including complete or final products such as laptop computers, televisions, computer monitors, automotive displays or equipment displays provided in other forms for vehicles, as well as mobile electronic devices such as smartphones or electronic pads.

Accordingly, in this disclosure, the display apparatus may include not only the display apparatuses in the narrow sense, such as LCMs, OLED modules, QD modules, but also set devices as application products or final consumer devices each including LCMs, OLED modules, QD modules, and the like.

Additionally, in some cases, an LCM, an OLED module, or a QD module, composed of a display panel and a panel driving unit may be referred to as “display apparatus” in a narrow sense, while an electronic device as a complete product including an LCM, an OLED module, or a QD module may be referred to as “set device.” For example, the narrow-sense display apparatus may include a display panel of liquid crystal (LCD), organic light-emitting diode (OLED), or quantum dot and a source printed circuit board (PCB) as a control unit for driving the display panel, while a set device may be a concept that further includes a set PCB, serving as a set control unit that is electrically connected to the source PCB and controls the entire set device.

The display panel used in the embodiments may include all types of display panels such as liquid crystal display panels, organic light-emitting diode (OLED) display panels, quantum dot (QD) display panels, and electroluminescent display panels, and is not limited to a specific display panel capable of bending a bezel with a flexible substrate for OLED display panel and a backplate support structure thereunder. In addition, the display panel used in the embodiment of this disclosure is not limited to the shape or size of the display panel.

For example, when the display panel is an organic light-emitting diode (OLED) display panel, it may include a plurality of gate lines and data lines and pixels formed at the intersection of the gate lines and data lines. In addition, it may be configured to include an array including thin-film transistors as components for selectively applying voltage to each pixel, an organic light-emitting diode (OLED) layer on the array, an encapsulation substrate or encapsulation layer arranged on the array to cover the organic light-emitting diode layer, etc. The encapsulation layer may protect the thin film transistors and the organic light-emitting device layer from the external impacts and prevent moisture or oxygen from penetrating into the organic light-emitting device layer. In addition, the layers formed on the array may include an inorganic light-emitting layer, such as a nano-sized material layer or quantum dots.

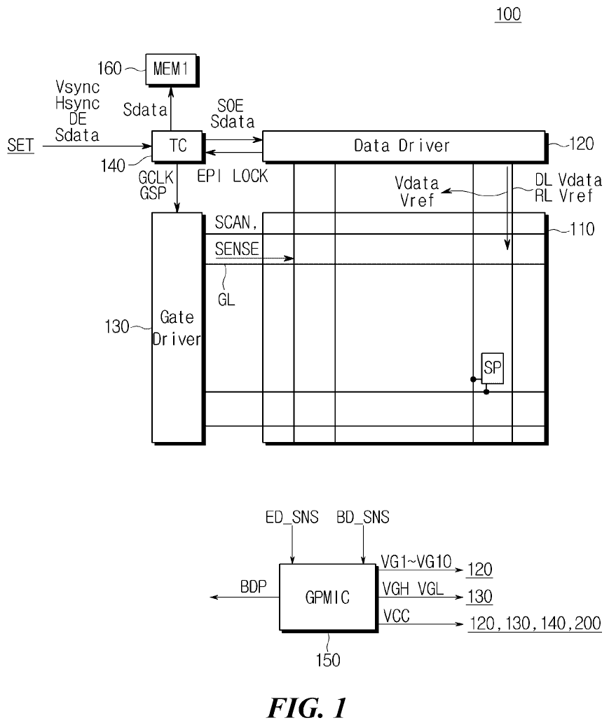

FIG. 1 is a diagram illustrating a display apparatus according to this disclosure.

Referring to FIG. 1, the display apparatus 100 includes a display panel 110, a data driving circuit 120 (also referred to as “a data driving unit 120”), a gate driving circuit 130 (also referred to as “a gate driving unit 130”), a timing controller 140, a power driving circuit 150 (also referred to as “a power driving unit 150”), and a memory 160.

The display panel 110 includes a plurality of gate lines GL, a plurality of reference lines RL, and a plurality of data lines DL. In the case where the resolution of the display panel is ultra-high definition (UHD), the number of gate lines GL is 2160, and the number of reference lines RL and data lines DL may each be 3840. A plurality of sub-pixels SP are arranged at the intersections of the gate lines GL and data lines DL. In one sub-pixel SP, a scan signal SCAN is input through the gate line GL, a data voltage Vdata is input through the data line DL, and a reference voltage Vref is input through the reference line RL. The data voltage Vdata is output from the data driving unit 120 and applied to the display panel 110 through the data line DL. The scan signal SCAN is output from the gate driving unit 130 and applied to the display panel 110 through the gate line GL.

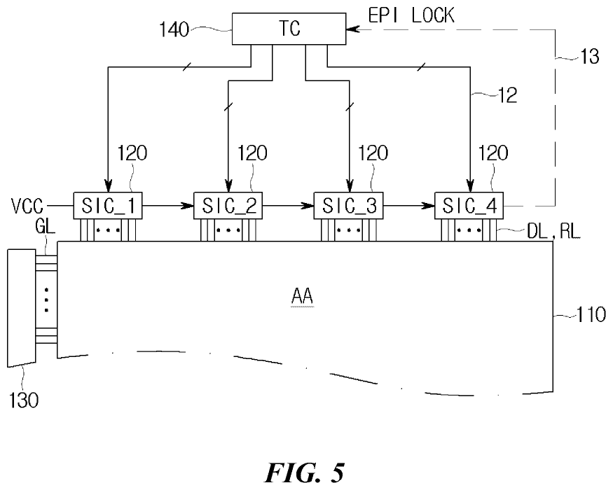

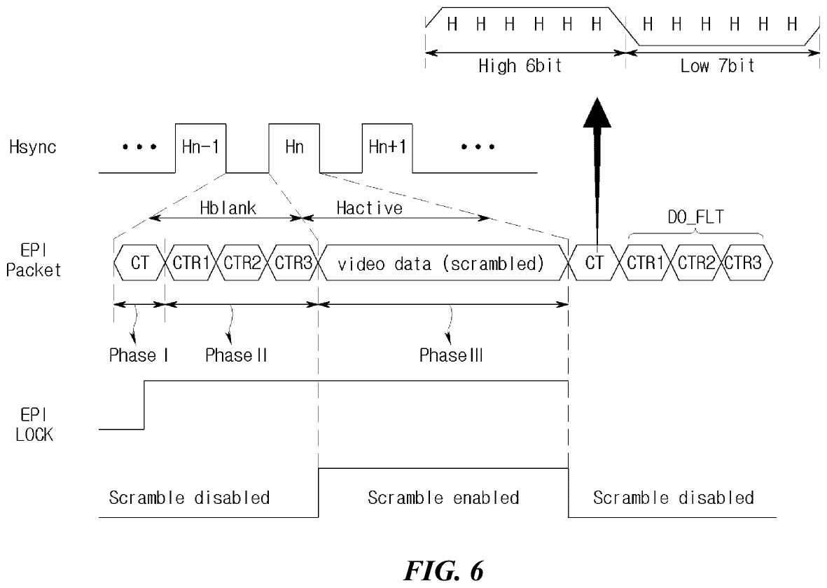

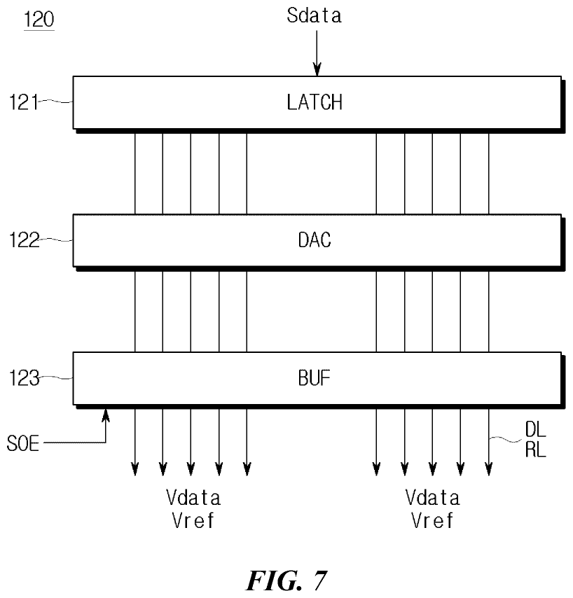

The data driving unit 120 receives image data Sdata output from the timing controller 140. The image data Sdata, which is serialized data, indicates the gray scale value that each sub-pixel SP should emit in digital form. The image data Sdata is transmitted through embedded clock point-to-point interface (EPI) communication and is scrambled. A detailed description of EPI communication and scrambling will be provided later with reference to FIG. 6 and other relevant figures. The data driving unit 120 converts the image data Sdata into an analog data voltage Vdata and outputs the voltage data to the data line DL. The data driving unit 120 outputs a reference voltage Vref, which may be a predetermined voltage level, to the reference line RL. The data driving unit 120 receives a source output enable signal (SOE) from the timing controller 140. The source output enable signal (SOE) is a signal input into a latch within the data driving unit 120. When the source output enable signal (SOE) is applied, the latch outputs the image data for one horizontal line to the digital-to-analog converter. The data driving unit 120 may take the form of an integrated circuit (IC). A detailed description of the data driving unit 120 will be provided later with reference to FIG. 7. Additionally, the data driving unit 120 may output an EPI Lock signal to the timing controller 140. A detailed description of the EPI Lock signal will be provided later with reference to FIG. 5 and other relevant figures.

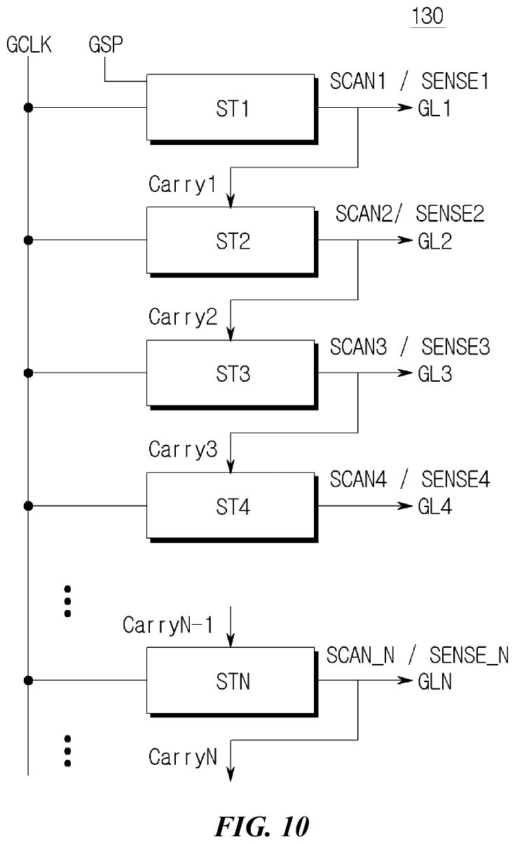

The gate driving unit 130 receives signals for controlling the transistors of the sub-pixels SP from the timing controller 140. The control signals include, for example, a gate clock GCLK and a gate start pulse GSP. The gate driving unit 130 outputs a scan signal SCAN for controlling the scan transistors and a sensing signal SENSE for controlling the sensing transistors to the display panel 110. The gate driving unit 130 may be positioned on one or both sides of the display panel 110 in the form of one or more integrated circuits (ICs). The gate driving unit 130 may also be implemented in a Gate In Panel GIP form, embedded within the non-display area of the display panel 110. A detailed description of the gate driving unit 130 will be provided later with reference to FIG. 10 and other relevant figures.

The timing controller 140 supplies various signals to the data driving unit 120 and the gate driving unit 130, thereby controlling the operation of the data driving unit 120 and the gate driving unit 130. The timing controller 140 receives vertical synchronization signal Vsync, horizontal synchronization signal Hsync, data enable signal DE, and image data Sdata from an external set system SET. The vertical synchronization signal Vsync, horizontal synchronization signal Hsync, and data enable signal DE are timing signals that control the sequence of operations of the display panel 110. The timing controller 140 may store the image data Sdata in the memory 160. The timing controller 140 may read the image data Sdata stored in the memory 160 and output the image data to the data driving unit 120.

The power driving unit 150 outputs DC power required for driving the pixel array of the display panel 110 and each driving unit 120, 130, 140, or 160 using a DC-DC converter. The power driving unit 150 outputs gamma reference voltages VG1 to VG10 to the data driving unit 120. The power driving unit 150 outputs gate high voltage VGH and gate low voltage VGL to the gate driving unit 130. The power driving unit 150 outputs converter voltage VCC. The converter voltage VCC may be a logic voltage required to drive ICs such as the data driving unit 120, gate driving unit 130, timing controller 140, and memory 160.

The power driving unit 150 may output a BDP signal. The BDP signal is output when the driving state of the display apparatus 100 is determined to be abnormal. The BDP signal may be output to the timing controller 140 and the set system SET.

The power driving unit 150 may receive an EVDD sensing signal ED_SNS. The EVDD sensing signal ED_SNS is a signal that senses the pixel driving voltage EVDD applied to the display panel 110. The power driving unit 150 may receive an EVSS sensing signal BD_SNS. The EVSS sensing signal BD_SNS is a signal that senses the pixel base voltage EVSS output from the display panel 110.

The memory 160 may receive and store image data Sdata from the timing controller 140. The image data Sdata is divided into frames and represents the gradation value assigned to each sub-pixel for each frame. The memory 160 may be referred to as a frame memory. The memory 160 may be a NAND-type memory.

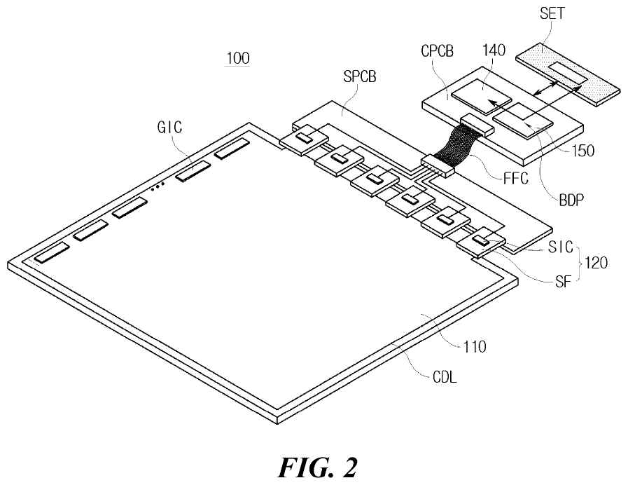

FIG. 2 is a perspective view illustrating a display apparatus according to this disclosure.

In the description, explanations identical to those provided above shall be incorporated by reference.

Referring to FIG. 2, the display apparatus 100 according to this disclosure includes a source integrated circuit (SIC) in the data driving unit 120 (see FIG. 1), which is implemented in the form of chip on film (COF) among various methods (such as TAB, COG, COF, etc.), and the gate driving unit 130 (see FIG. 1), which is implemented in the form of gate in panel (GIP) among various methods (such as TAB, COG, COF, GIP, etc.).

The gate driving unit 130, implemented in the form of GIP, has a plurality of gate integrated circuits (GICs) included in the gate driving unit 130, which are directly formed in the non-display area of the display panel 110. The GICs receive various signals (such as clock signals, gate start pulses, etc.) required for generating the scan signal via the gate driving-related signal wiring arranged in the non-display area.

One or more SICs included in the data driving unit 120 are mounted on a source film SF, one side of which is electrically connected to the display panel 110. Additionally, wiring for electrically connecting the SICs and the display panel 110 is arranged on the upper side of the source film SF.

The display apparatus 100 includes a SPCB for circuit connections between the plurality of SICs and other devices, and a control printed circuit board (CPCB) for mounting control components and various electrical devices.

The other side of the source film (SF), where the SIC is mounted, is connected to the SPCB. The source film (SF), with the SIC mounted, has one side electrically connected to the display panel 110 and the other side electrically connected to the SPCB.

The CPCB houses the timing controller 140 and the power driving unit 150. The timing controller 140 may control the operation of the data driving unit 120 and the gate driving unit 130. The power driving unit 150 may supply driving voltages or currents to the display panel 110, data driving unit 120, and gate driving unit 130, and may also control the supplied voltage or current.

The SPCB and the CPCB may be electrically connected through a connection member, which may be a flexible flat cable (FFC). For example, the connection member may be a flexible printed circuit (FPC). Additionally, the source printed circuit board (SPCB) and the CPCB may be integrated and implemented as a single printed circuit board.

The CPCB of the display apparatus 100 may be electrically connected to the set system (SET). The timing controller 140 and the power driving unit 150 may be arranged on the CPCB.

The power driving unit 150 may output a BDP signal to the timing controller 140 and the set system (SET).

The BDP signal is a signal indicating that the operation of the display apparatus 100 is abnormal. The BDP signal may be triggered in various cases.

First, the power driving unit 150 may output the BDP signal when the operation of the timing controller 140 is abnormal. For example, when a line defect occurs due to real-time sensing of degradation in a driving transistor during operation of the display apparatus 100, the BDP signal may be output. Alternatively, when synchronization between the EPI communication of the timing controller 140 and the data driving unit 120 is broken, the EPI lock signal (EPI LOCK, see FIG. 1) is generated. When the EPI lock signal EPI LOCK occurs, the BDP signal may be output.

Additionally, the power driving unit 150 may output the BDP signal when an abnormality occurs in its own operation. For example, when a voltage output from the power driving unit 150 (e.g., gate high voltage VGH, gate low voltage VGL (see FIG. 1), gamma reference voltages VG1 to VG10 (see FIG. 1)) exceeds a predetermined level, the BDP signal may be output. Alternatively, when the power driving unit 150 does not operate, the BDP signal may be output.

The power driving unit 150 may output the BDP signal when an abnormality occurs in the operation of a level shifter (not shown) mounted on the CPCB. For example, when the output voltage of the level shifter exceeds a predetermined level, the BDP signal may be output.

Furthermore, the power driving unit 150 may output the BDP signal when an abnormality occurs in the operation of the display panel 110. To this end, a crack detection line CDL may be arranged along the outermost edge of the non-display area of the display panel 110. A test voltage may be applied to the crack detection line CDL. When the test voltage is not output from the crack detection line CDL, it may be determined that a crack has occurred in the display panel 110. For example, when the output of the test voltage is below a predetermined level, it may be determined that the crack detection line CDL is open, and the BDP signal may be output. Alternatively, when the output of the test low voltage is greater than a predetermined level, it may be determined that the crack detection line CDL is shorted to the pixel driving voltage EVDD line, and the BDP signal may be output.

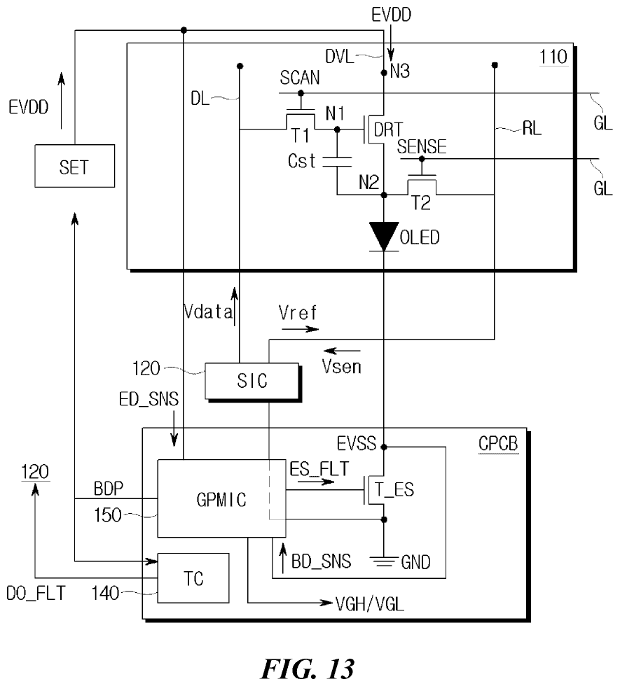

Additionally, the power driving unit 150 may output the BDP signal based on the EVDD sensing signal ED_SNS (see FIG. 1 and FIG. 13). When the voltage level of the EVDD sensing signal ED_SNS exceeds a predetermined level, it may be determined that an overcurrent is being applied to the display panel 110, and the BDP signal may be output.

Furthermore, the power driving unit 150 may output the BDP signal based on the EVSS sensing signal BD_SNS (see FIG. 1 and FIG. 13). When the voltage level of the EVSS sensing signal BD_SNS exceeds a predetermined level, it may be determined that a short circuit has occurred in the driving transistor, and the BDP signal may be output.

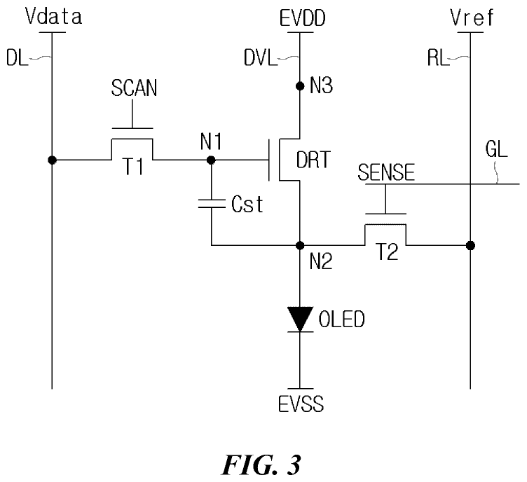

FIG. 3 is a diagram illustrating a sub-pixel according to this disclosure.

In the description, explanations identical to those provided above shall be incorporated by reference.

Referring to FIG. 3, one sub-pixel SP may include a data line DL, a gate line GL), a driving voltage line DVL, and a reference line RL. The gate line GL is connected to the gate driving unit 130, as shown in FIG. 1, and scan signals SCAN and sensing signals SENSE are applied.

The sub-pixel SP includes an organic light-emitting diode OLED, a driving transistor DRT, a first transistor T1 connected between a first node and the data line DL, a second transistor T2 connected between a second node and the reference line RL, and a storage capacitor Cst connected between the first node N1 and the second node N2.

The organic light-emitting diode OLED includes an anode electrode, an organic light-emitting layer, and a cathode electrode. The second node N2 is connected to the anode electrode, and the pixel base voltage EVSS is connected to the cathode electrode. The driving transistor DRT supplies driving current to the organic light-emitting diode OLED. The first node N1 is the gate node of the driving transistor DRT. The second node N2 is the source node of the driving transistor DRT. The third node N3 is the drain node of the driving transistor DRT. The third node N3 is connected to the pixel driving voltage EVDD.

The storage capacitor Cst may be electrically connected between the first node N1 and the second node N2 and maintain the data voltage Vdata applied through the data line DL for at least one frame.

The first transistor T1 may be turned on by the scan signal SCAN to apply the data voltage Vdata, supplied through the data line DL, to the first node N1. The first transistor T1 may be referred to as a scan transistor or a switching transistor. The second transistor T2 may be turned on by the sensing signal SENSE to supply the reference voltage Vref to the second node N2. Alternatively, the second transistor T2 may be turned on by the sensing signal SENSE to output the voltage across the second node N2 to the reference line RL. The second transistor T2 may be referred to as a sensing transistor or an initialization transistor.

In FIG. 3, although the gate line GL connected to the first transistor T1 and the gate line GL connected to the second transistor T2 are shown as separate lines, this is not restrictive. A single gate line GL may be connected to both the first transistor T1 and the second transistor T2. In this case, by controlling the pulse of the signal applied to the gate line GL, both the first transistor T1 and the second transistor T2 may be controlled.

In FIG. 3, the transistors are illustrated as N-type. However, at least one of the transistors may be formed as P-type.

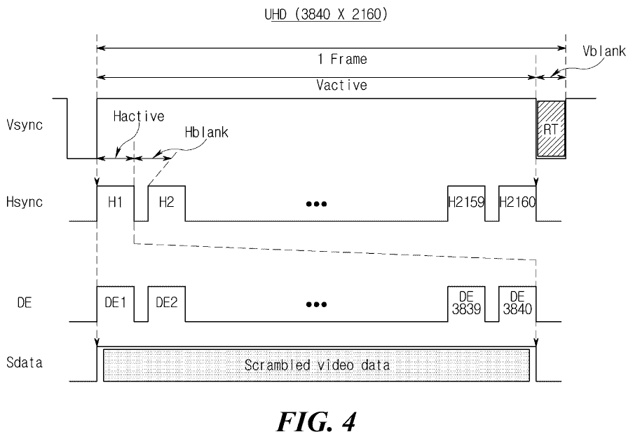

FIG. 4 is a timing diagram illustrating the signals applied to a timing controller.

Referring to FIG. 4, the vertical synchronization signal Vsync, horizontal synchronization signal Hsync, data enable signal DE, and image data Sdata are shown.

For a UHD resolution display panel, there are a total of 3840 vertical lines (i.e., data lines in the vertical direction) and 2160 horizontal lines (i.e., gate lines in the horizontal direction). “In this disclosure, UHD serves as an illustrative example.

The vertical synchronization signal Vsync is a representative signal that defines one frame (1 Frame). For a 120 Hz operation, 120 frames are displayed per second, meaning one vertical synchronization signal Vsync corresponding to one frame lasts approximately 8.33 [ms]. One vertical synchronization signal Vsync may be divided into a vertical active period Vactive and a vertical blank period Vblank. The vertical active period Vactive is the period when the image is displayed on the screen of the display apparatus. The vertical blank period Vblank is the period for preparing the display of the next frame. During the vertical blank period Vblank, degradation of the organic light-emitting display apparatus may be sensed. The vertical blank period Vblank may last about 0.3 [ms]. This sensing may be referred to as real-time sensing (RT) since it is performed during the operation of the display apparatus.

The horizontal synchronization signal Hsync is a signal that defines one horizontal line. For UHD, one vertical synchronization signal Vsync includes 2160 horizontal periods, which corresponds to the total number of horizontal lines (i.e., gate lines). The horizontal period may be referred to as 1H. One horizontal period may be divided into a horizontal active period Hactive and a horizontal blank period Hblank. The period between one horizontal active period (e.g., H1) and the next horizontal active period (e.g., H2) may be defined as the horizontal blank period Hblank. The horizontal active period Hactive is the period during which image data Sdata is transmitted. The horizontal blank period Hblank is the period when image data Sdata is not transmitted. Instead, during the horizontal blank period Hblank, clock training patterns and control packets may be transmitted. Further details will be provided later with reference to FIG. 6.

One horizontal active period Hactive corresponds to a plurality of data enable signals DE. The data enable signal DE defines the number of sub-pixels connected to one horizontal line. For UHD, one horizontal synchronization signal Hsync includes 3840 data enable signals DE, which corresponds to the total number of vertical lines (i.e., data lines). During one horizontal active period Hactive, image data Sdata corresponding to the sub-pixels connected to one horizontal line is transmitted. Each data enable period DE1 to DE3840 may distinguish the respective sub-pixels SP. For the purpose of reducing the amount of transmitted information and making it robust to noise, the image data Sdata transmitted via EPI communication may be scrambled. Further details will be provided later with reference to FIG. 6.

FIG. 5 is a diagram illustrating the EPI communication between a timing controller and a data driving unit according to this disclosure.

Referring to FIG. 5, the timing controller 140 and the data driving unit 120 are connected to each other for communication. The data driving unit 120 may be composed of a plurality of source integrated circuits SIC_1 to SIC_4. The communication between the timing controller 140 and the data driving unit 120 may be referred to as EPI communication.

EPI (Embedded clock Point to point Interface) communication connects the timing controller 140 and the plurality of source integrated circuits SIC_1 to SIC_4 in a point-to-point manner, minimizing the number of wirings between the timing controller 140 and the source integrated circuits SIC_1 to SIC_4. Since EPI communication transmits an EPI signal, which includes control data and image data with an embedded clock, through a data wiring pair 12, separate clock and control wirings are not required.

According to EPI communication, each of the plurality of source integrated circuits SIC_1 to SIC_4 has a built-in clock recovery unit for clock and data recovery (CDR). The timing controller 140 transmits a clock training pattern to the plurality of source integrated circuits SIC_1 to SIC_4 to stabilize the output phase and frequency of the clock recovery unit. The clock recovery units embedded in the plurality of source integrated circuits SIC_1 to SIC_4, upon receiving the clock training pattern and clock signal through the data wiring pair 12, restore the clock signal and generate a multi-phase internal clock.

Once the phase and frequency of the internal clock are locked, the plurality of source integrated circuits SIC_1 to SIC_4 feedback an EPI LOCK signal at a logic high level to the timing controller 140, indicating an output stability state. The source integrated circuits SIC_1 to SIC_4 receive a converter voltage VCC to drive the integrated circuits. The EPI LOCK signal is output to the timing controller 140 through a feedback wiring 13 connected between one of the source integrated circuits SIC_4 and the timing controller 140.

In the signal transmission protocol of EPI communication, the timing controller 140 transmits the clock training pattern to the source integrated circuits SIC_1 to SIC_4 before transmitting control packets and image data. The clock recovery units of the source integrated circuits SIC_1 to SIC_4 restore the received clock through the data wiring pair 12 based on the clock training pattern and generate an internal clock. Additionally, once the phase and frequency of the internal clock are stably locked, a data link with the timing controller 140 is established. The timing controller 140, in response to the EPI LOCK signal received from the source integrated circuit SIC_4, begins transmitting control packets and image data to the source integrated circuits SIC_1 to SIC_4.

The source integrated circuits SIC_1 to SIC_4 restore control packets from the signals received through the data wiring pair 12 and generate control data. The control data may include a vertical synchronization signal Vsync, a horizontal synchronization signal Hsync, and a data enable signal DE. Additionally, the control data may include a control signal for enabling or disabling the scrambling of image data Sdata.

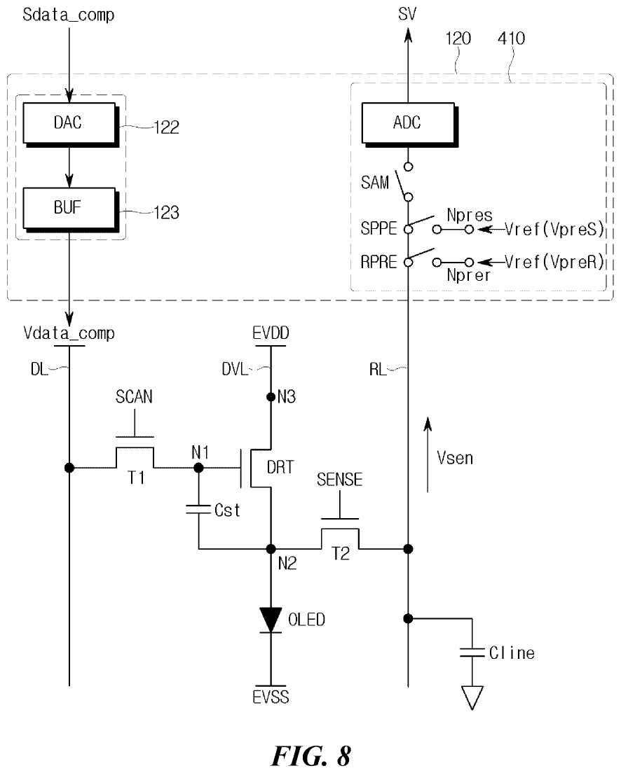

According to the disclosure, the control data may include a data output floating signal DO_FLT (see FIG. 6). The data output floating signal is a signal that blocks the output of the data driving unit 120 under the control of the timing controller 140. Upon receiving control data including the data output floating signal from the timing controller 140, the data driving unit 120 may be physically disconnected from the data line DL and the reference line RL. For example, a multiplexer switch arranged at the output stage of the data driving unit 120 may be opened. Alternatively, switches located within other components of the data driving unit 120 (e.g., converter 122 and buffer 123 in FIG. 7) may be opened. Furthermore, for example, a sampling switch SAM arranged within the data driving unit 120 may be opened (see FIG. 8), causing the reference line RL to float.

FIG. 6 is a timing diagram illustrating EPI communication according to this disclosure.

In the description, explanations identical to those provided above shall be incorporated by reference.

Referring to FIG. 6, a horizontal synchronization signal Hsync, an EPI packet EPI Packet, and an EPI lock signal EPI LOCK are illustrated.

The horizontal synchronization signal Hsync is a signal transmitted from the timing controller 140 to the data driving unit 120. The horizontal synchronization signal Hsync consists of a plurality of horizontal periods Hn−1, Hn, and Hn+1. Any given horizontal period Hn is divided into a horizontal blanking period Hblank and a horizontal active period Hactive.

The EPI packet is a signal transmitted from the timing controller 140 to the data driving unit 120. During the horizontal blanking period Hblank, the EPI packet includes a clock training pattern CT and control packets CTR1, CTR2, and CTR3. The clock training pattern CT is a signal used to synchronize the clock between the timing controller 140 and the data driving unit 120 during EPI communication. For example, the clock training pattern CT may be a predetermined binary data sequence as shown at the top of FIG. 6. For illustrative purposes, the clock training pattern CT may consist of 6 high bits and a 7 low bits.

The control packets CTR1, CTR2, and CTR3 are signals that contain commands for the timing controller 140 to control the data driving unit 120. The control packets CTR1, CTR2, and CTR3 may include a vertical synchronization signal Vsync, a horizontal synchronization signal Hsync, and a data enable signal DE.

In this disclosure, a data output floating signal DO_FLT may be transmitted from the timing controller 140 to the data driving unit 120 to restrict the output of the data driving unit 120. The data output floating signal DO_FLT may be transmitted through the control packets CTR1, CTR2, and CTR3. When the data output floating signal DO_FLT is included as a result of unpacking the control packets CTR1, CTR2, and CTR3, the data driving unit 120 may block the connection with the display panel 110. For example, the data line DL and the reference line RL connecting the display panel 110 and the data driving unit 120 may be physically floated. For illustrative purposes, the mux switch (not shown) connected to the output buffer of the data driving unit 120 may be opened. Alternatively, switches located within other components of the data driving unit 120 (e.g., converter 122 and buffer 123 in FIG. 7) may be opened. Alternatively, when the sampling switch SAM (see FIG. 8) placed within the data driving unit 120 is opened, the reference line RL may be floated.

During the horizontal active period Hactive, the EPI packet contains image data. The image data may be scrambled image data. In contrast, the clock training pattern CT and control packets CTR1, CTR2, and CTR3 are not scrambled and may be transmitted in their original format.

The period during which the clock training pattern CT is transmitted may be referred to as Phase I. The period during which the control packets CTR1, CTR2, and CTR3 are transmitted may be referred to as Phase II. The period during which the video data is transmitted may be referred to as Phase III.

In Phase I, a clock training pattern CT with a constant frequency is transmitted from the timing controller 140 to the data driving unit 120, and the EPI lock signal EPI LOCK at a logic high level is input into the timing controller 140 through the feedback wiring 13 (see FIG. 5). The timing controller 140 performs Phase II to begin transmitting the control packets CTR1, CTR2, and CTR3. During Phase II, when the EPI lock signal EPI LOCK maintains a logic high level, the timing controller 140 performs Phase III. During Phase III, the image data may be transmitted.

FIG. 7 is a diagram illustrating a data driving unit according to this disclosure.

In the description, explanations identical to those provided above shall be incorporated by reference.

Referring to FIG. 7, the data driving unit 120 includes a latch 121, a converter 122, and a buffer 123.

The latch 121 receives the image data Sdata in digital form from the timing controller 140. The latch 121 parallelizes the image data Sdata input serially. That is, the latch 121 divides the serial image data Sdata into chunks corresponding to one horizontal line and outputs the divided image data Sdata to the converter 122.

The converter 122 is a digital-to-analog converter that converts digital signals into analog signals. The converter 122 converts the data input from the latch 121 from a digital form to an analog form. The data output from the converter 122 may have a voltage level boosted by a gamma converter (not shown) and a level shifter (not shown). The converter 122 may have multiple switches inside, and the voltage boost level may be controlled by turning these switches on and off.

The buffer 123 outputs the data voltage Vdata to the data line DL through an output buffer assigned to each channel of the data driving unit 120. To control the output, the source output enable signal SOE is input into the buffer 123. The data voltage Vdata output to the data line DL is applied to each sub-pixel SP, and the luminance image corresponding to the data voltage Vdata is emitted from each sub-pixel SP.

FIG. 8 is a circuit diagram illustrating the sensing of a driving transistor according to this disclosure.

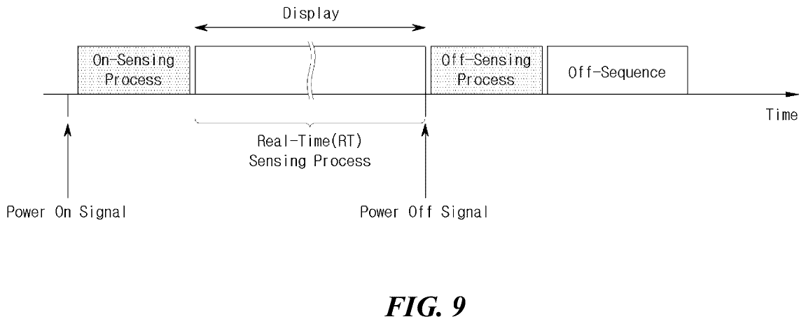

FIG. 9 is a diagram illustrating the sensing sequence occurring at various timings according to this disclosure.

In the description, explanations identical to those provided above shall be incorporated by reference.

As described with reference to FIG. 3, the sub-pixel SP according to this disclosure includes a driving transistor DRT. The driving transistor DRT undergoes changes in its characteristics depending on the operation of the display apparatus. Therefore, the characteristics of the driving transistor DRT must be compensated, and to perform this compensation, the amount of change must be sensed.

Referring to FIG. 8, the characteristics of the driving transistor DRT of the sub-pixel SP may be sensed from the sensing voltage Vsen obtained by sensing the reference line RL according to the disclosure. For sensing operation, the reference line RL may output a reference voltage Vref to the sub-pixel SP, or the sensing voltage Vsen reflecting the degree of degradation of the sub-pixel SP may be output to the data driving unit 120. The reference line RL may also be referred to as a reference voltage line. The sensing voltage Vsen, which is in analog form, may be converted into a digital sensing value SV through an AD converter ADC that converts analog signals into digital signals. The sensing value SV may be output to the timing controller 140.

When the sensing operation according to this disclosure is performed, the characteristics of the driving transistor DRT are reflected as the voltage at the second node N2, which is Vdata-Vth. Here, Vth is the threshold voltage of the driving transistor DRT.

The voltage at the second node N2 of the driving transistor DRT may be equal to the voltage of the reference line RL when the second transistor T2 is in a turned-on state. The voltage at the second node N2 is charged in the line capacitor Cline on the reference line RL.

The AD converter ADC converts the analog sensing voltage Vsen into a digital sensing value SV. The AD converter ADC may be disposed either inside or outside the data driving unit 120.

The sensing reference switch SPRE controls the connection between the sensing reference voltage node Npres and the reference line RL. When the sensing reference switch SPRE is turned on, a reference voltage for sensing VpreS is applied to the reference line RL. The image reference switch RPRE controls the connection between the image reference voltage node Nprer and the reference line RL. When the image reference switch RPRE is turned on, a reference voltage for image driving VpreR is applied to the reference line RL.

The timing controller 140 may output image data Sdata_comp, compensated for degradation defined by the sensing value SV, to the data driving unit 120. The data driving unit 120 may output a data voltage Vdata_comp, compensated for degradation, to the sub-pixel.

Referring to FIG. 9, when a power-on signal is applied to the display apparatus, an on-sensing process may proceed for about 2-3 seconds. Additionally, during the display of images on the display apparatus, a real-time sensing process RT may proceed. As described with reference to FIG. 4, real-time sensing RT may occur for about 0.2 milliseconds during the blank period Vblank within a single frame. When a power-off signal is applied to the display apparatus, an off-sensing process may proceed for about 300 seconds. When the power-off signal is applied, the display apparatus does not actually turn off but continues to drive for sensing purposes. Once the sensing operation is completed, the power of the display apparatus is turned off.

This sensing sequence allows the threshold voltage and mobility of the driving transistor DRT to be sensed. In general, threshold voltage sensing takes a relatively long time and may occur during the off-sensing process. Mobility sensing, on the other hand, takes a relatively short time and may occur during the on-sensing process and real-time sensing process.

FIG. 10 is a diagram illustrating a gate driving unit according to this disclosure.

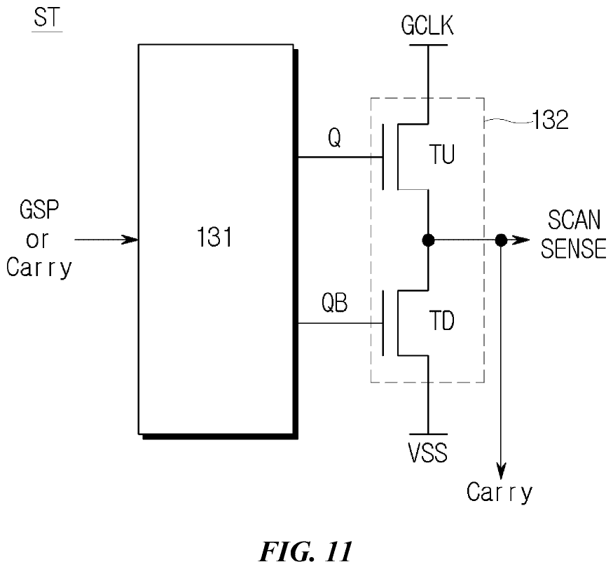

FIG. 11 is a diagram illustrating the stages of a gate driving unit according to this disclosure.

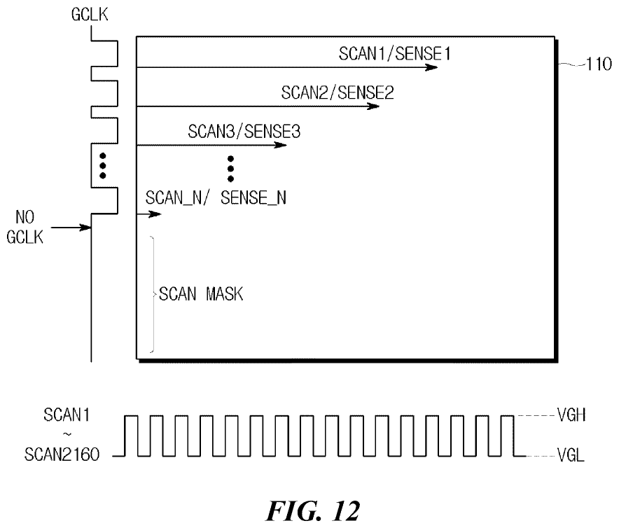

FIG. 12 is a diagram illustrating a scan mask according to this disclosure.

A description is provided of the gate driving unit according to the disclosure with reference to FIGS. 10 to 12.

In the description, explanations identical to those provided above shall be incorporated by reference.

Referring to FIG. 10, the gate driving unit 130 according to the disclosure includes a plurality of stages ST. The signals output from each of the stages ST may be a scan signal SCAN and a sensing signal SENSE. The scan signal SCAN and sensing signal SENSE are input to the sub-pixels SP via the gate lines GL. For the convenience of explanation, the description will focus on the scan signal SCAN. The same technical principles may be applied to the sensing signal SENSE.

Each of the stages ST1 to STN receives a gate clock GCLK as input. The gate clock GCLK may be a signal output from the timing controller 140 and input to the gate driving unit 130.

Each of the stages ST1 to STN may have its operation initiated by a gate start pulse GSP or the carry signal CarryN−1 from the previous stage.

The first stage ST1 may have its operation initiated by the gate start pulse GSP. The first stage ST1 outputs the first carry signal Carry1 to the second stage ST2. The first stage ST1 outputs the first scan signal SCAN1 to the first gate line GL1.

The second stage ST2 may have its operation initiated by the first carry signal Carry1 from the previous stage. The second stage ST2 outputs the second carry signal Carry2 to the third stage ST3. The second stage ST2 outputs the second scan signal SCAN2 to the second gate line GL2.

The third stage ST3 may have its operation initiated by the second carry signal Carry2 from the previous stage. The third stage ST3 outputs the third carry signal Carry3 to the fourth stage ST4. The third stage ST3 outputs the third scan signal SCAN3 to the third gate line GL3.

The fourth stage ST4 may have its operation initiated by the third carry signal Carry3 from the previous stage. The fourth stage ST4 outputs the fourth carry signal Carry4 to the next stage. The fourth stage ST4 outputs the fourth scan signal SCAN4 to the fourth gate line GL4.

The Nth stage STN may have its operation initiated by the (N−1)th carry signal CarryN−1, which is the carry signal from the previous stage. The Nth stage STN outputs the Nth carry signal CarryN to the next stage. The Nth stage STN outputs the Nth scan signal SCAN_N to the Nth gate line GLN.

Referring to FIG. 11, any one stage ST is illustrated. Any one stage ST includes a shift register 131 and a buffer circuit 132.

The shift register 131 may receive a gate start pulse GSP from the timing controller 140. Alternatively, the shift register 131 may receive a carry signal Carry from the previous stage. The buffer circuit 132 receives a gate clock GCLK from the timing controller 140. The scan signal SCAN output from the buffer circuit 132 is output to the gate line. The carry signal Carry output from the buffer circuit 132 is output to the next stage ST.

When the scan signal SCAN is output to the first gate line GL by the gate start pulse GSP, the next shift register 131 activated by the carry operation. Due to the operation of the next shift register 131 and buffer circuit 132, the scan signal SCAN is output to the second gate line GL.

Therefore, the shift register 131 may initiate operation by the gate start pulse GSP or the carry signal Carry. Additionally, the buffer circuit 132 may output the scan signal SCAN or the carry signal Carry based on the gate clock GCLK.

When the gate clock GCLK is not output from the timing controller 140 to the gate driving unit 130, the scan signal SCAN may not be output. Additionally, the carry signal Carry may not be output either. Since the carry signal Carry is not output, the operation of the next stage ST may not be initiated, and consequently, the next scan signal SCAN may not be output either.

As shown in FIG. 12, when the gate clock GCLK is output from the timing controller 140, the first scan signal SCAN1 to the Nth scan signal SCAN_N may be output sequentially. When the output of the scan signal SCAN is interrupted after the output of the Nth scan signal SCAN_N, the (N+1)th scan signal may not be output. Since the (N+1)th carry signal may not be output, the (N+2)th scan signal and subsequent scan signals may not be output either.

In this manner, the phenomenon where the scan signal SCAN is not output due to the interruption of the gate clock GCLK output is defined as a scan mask SCAN MASK. FIGS. 10 to 12 are intended to explain one example of a scan mask, and it should be understood that the technical spirit of this disclosure is not limited thereto. It should also be understood that other methods of interrupting the output of the scan signal SCAN are included within the technical spirit of this disclosure. For example, when generating a scan clock using the rising edge of the gate clock, abbreviated as G-CLK, and the falling edge of the main clock, abbreviated as M-CLK, a scan mask may also be implemented by eliminating the G-CLK input to the gate driving unit 130.

FIG. 13 is a diagram illustrating a display apparatus according to this disclosure.

In the description, explanations identical to those provided above shall be incorporated by reference.

FIG. 13 illustrates the display panel 110, which receives the pixel driving voltage EVDD through the driving voltage line DVL from the set system SET.

The data driving unit 120 supplies the data voltage Vdata and reference voltage Vref to the display panel 110. The data driving unit 120 receives the sensing voltage Vsen from the display panel 110. The data line DL and reference line RL are grounded through the data driving unit 120 and power driving unit 150, passing through the control printed circuit board CPCB ground node GND. Depending on the configuration, the data line DL and reference line RL may be grounded through the data driving unit 120 without passing through the power driving unit 150.

The timing controller 140 and power driving unit 150 are disposed on the control printed circuit board CPCB. The power driving unit 150 outputs the BDP signal to the set system SET and timing controller 140. The power driving unit 150 outputs the gate high voltage VGH and gate low voltage VGL. The power driving unit 150 receives the EVDD sensing signal ED_SNS and EVSS sensing signal BD_SNS. The power driving unit 150 also outputs the EVSS floating signal ES_FLT that controls the EVSS transistor T_ES. According to the disclosure, the EVSS transistor T_ES is disposed on the control printed circuit board CPCB.

According to the disclosure, the EVSS transistor T_ES is disposed on the control printed circuit board CPCB. The input node of the EVSS transistor T_ES is connected to the pixel base voltage EVSS. The pixel base voltage EVSS is the voltage of the output node of the organic light-emitting diode OLED. The output node of the EVSS transistor T_ES is connected to the ground node GND. The control node of the EVSS transistor T_ES is connected to the power driving unit 150.

When the EVSS transistor T_ES is turned on, the pixel base voltage EVSS node is connected to the ground node GND.

When the EVSS transistor T_ES is turned off, the pixel base voltage EVSS node is floating. Therefore, the path along which the pixel driving voltage EVDD flows through the driving voltage line DVL is blocked.

The display apparatus 100 according to this disclosure may perform the following operations.

### Turn-on Discharge

A voltage corresponding to the condition where an image is displayed may be applied to the first node N1 and the second node N2. The voltage corresponding to the condition where an image is displayed refers to, for example, a voltage that outputs a non-zero gray scale image. For instance, the data voltage Vdata and reference voltage Vref for displaying the image of the last frame may be input to the data line DL and reference line RL, respectively. This is referred to as “Turn-On Discharge” in this disclosure.

### Turn-Off Discharge

A voltage corresponding to the condition where an image is not displayed may be applied to the first node N1 and the second node N2. The voltage corresponding to the condition where no image is displayed refers to, for example, a voltage that outputs a zero gray scale image. For example, the voltage levels of the data voltage Vdata and reference voltage Vref may be 0V. This is referred to as “Turn-Off Discharge” in this disclosure.

### EVSS Floating

The EVSS transistor T_ES is connected between the pixel base voltage EVSS node and the ground GND node. The signal that controls the turn-on and turn-off of the EVSS transistor T_ES is the EVSS floating signal ES_FLT. When the EVSS transistor T_ES is turned on, the path for the pixel driving voltage EVDD is connected to the ground GND node, which indicates that the current path of the driving voltage line DVL is established. When the EVSS transistor T_ES is turned off, the path for the pixel driving voltage EVDD is opened, which indicates that the current path of the driving voltage line DVL is blocked. The opening of the pixel base voltage EVSS node, or the blocking of the current path of the driving voltage line DVL, is referred to as “EVSS Floating” in this disclosure.

### Scan Mask

As described with reference to FIGS. 10 to 12, the scan signal SCAN and sensing signal SENSE output from the gate driving unit 130 may be blocked under the control of the timing controller 140. This is referred to as a “Scan Mask” in this disclosure.

### Data Output Floating

As described with reference to FIGS. 6 to 9, the output of the data driving unit 120 may be floated under the control of the timing controller 140. That is, the data line DL and reference line RL may be opened. For example, based on the data output floating signal DO_FLT transmitted through the control packet of the EPI communication from the timing controller 140, the data driving unit 120 may block its output. That is, the data driving unit 120 may physically or electrically open the reference line RL and data line DL. This is referred to as “Data Output Floating” in this disclosure.

### Gate Low Voltage Zero Level Control

The power driving unit 150 outputs the gate high voltage VGH and gate low voltage VGL to the gate driving unit 130. The gate high voltage VGH and gate low voltage VGL determine the maximum and minimum voltage levels of the pulse-type scan signal SCAN and sensing signal SENSE applied through the gate line GL. In other words, the scan signal SCAN and sensing signal SENSE are pulse voltages that swing between the gate high voltage VGH and gate low voltage VGL. In particular, for the gate low voltage VGL, a negative voltage level may be used to maximize the turn-off performance of the first transistor T1 (the scan transistor) and the second transistor T2 (the sensing transistor). For example, during normal operation of the display apparatus, the gate low voltage VGL may be −6V. According to embodiments described later in this disclosure, at a predetermined time point, the power driving unit 150 may output the gate low voltage VGL as a zero-level voltage (i.e., substantially 0V). This is referred to as “Gate Low Voltage Zero Level Control” in this disclosure.

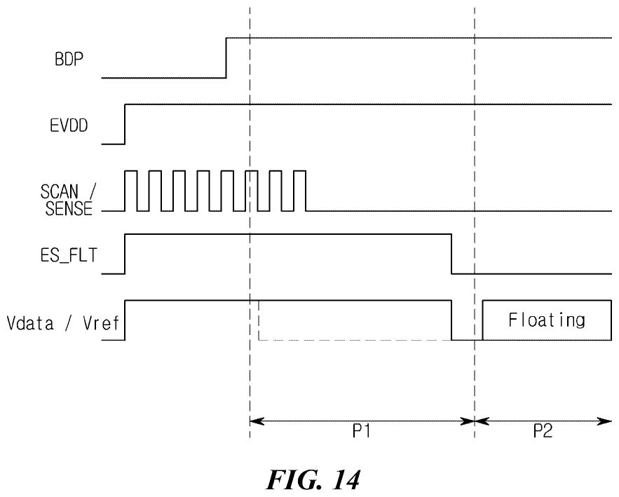

FIG. 14 is a waveform diagram according to the first embodiment of this disclosure.

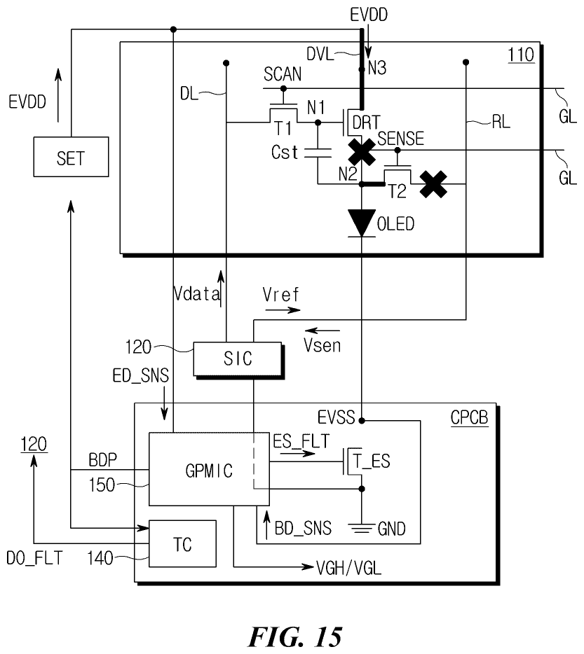

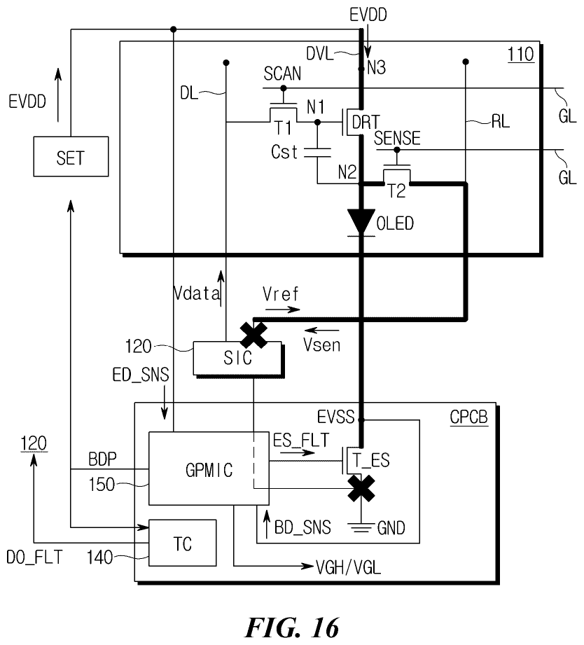

FIGS. 15 and 16 are diagrams illustrating the operational states of the display apparatus according to the first embodiment of this disclosure.

The first embodiment of the disclosure will be described with reference to FIGS. 14 to 16.

FIG. 14 illustrates a first period P1 and a second period P2.

Before the first period P1, the BDP signal BDP is turned on. As described with reference to FIG. 2, when predetermined conditions are met, it is determined that the operation of the display apparatus 100 is abnormal, and the power driving unit 150 generates the BDP signal. The BDP signal BDP is output to the set system SET and the timing controller 140.

Upon receiving the BDP signal, the set system SET should block the pixel driving voltage EVDD. However, for various reasons, the blocking of the pixel driving voltage EVDD may not occur.

In this case, the unintended flow of the pixel driving voltage EVDD may cause a burnout in the organic light-emitting diode OLED. That is, the pixel driving voltage EVDD may be applied to the OLED via the driving transistor DRT, causing an issue.

Furthermore, the unintended flow of the pixel driving voltage EVDD may cause a burnout in the integrated circuit of the data driving unit 120. In other words, the pixel driving voltage EVDD is connected to the data driving unit 120 via the second transistor T2 and the reference line RL at the second node N2, which may lead to the pixel driving voltage EVDD being applied to the data driving unit 120.

During the first period P1, a scan mask may be performed. When the scan mask is performed, the scan signal SCAN and sensing signal SENSE are not output to the gate line GL. As shown in FIG. 15, since the scan signal SCAN is not applied, the first transistor T1 is turned off. Since the first transistor T1 is turned off, the drive transistor DRT is also turned off. Additionally, since the sensing signal SENSE is not applied, the second transistor T2 is turned off.

With the first transistor T1 being turned off, the drive transistor DRT is also turned off, which prevents the pixel driving voltage EVDD from being applied to the organic light-emitting diode OLED. This may prevent burnout in the organic light-emitting diode OLED.

With the second transistor T2 turned off, the pixel driving voltage EVDD is not applied to the reference line RL, which prevents the pixel driving voltage EVDD from being applied to the data driver 120. This may prevent burnout in the data driver 120.

Optionally, before performing the scan mask, either turn-on discharge or turn-off discharge may be attempted. Turn-on discharge, as denoted by the solid line in FIG. 14, involves applying the data voltage Vdata and reference voltage Vref (i.e., a voltage level greater than or equal to a certain magnitude) to the data line DL and reference line RL, respectively. Turn-off discharge, as denoted by the dashed line, involves applying a 0V voltage to the data line DL and reference line RL.

Meanwhile, even though the scan mask is performed, the first transistor T1 may be turned on due to leakage, causing the drive transistor DRT to turn on, or the drive transistor DRT may turn on due to a short circuit in the drive transistor DRT. In this case, the pixel driving voltage EVDD may flow to the organic light-emitting diode OLED through the drive voltage line DVL. Additionally, a short circuit between the drive voltage line DVL and reference line RL may cause the pixel driving voltage EVDD to be applied to the reference line RL and flow into the data driver 120.

Referring to FIG. 14, during the second period P2, EVSS floating may be performed. To achieve this, the power driving unit 150 lowers the EVSS floating signal ES_FLT to the turn-off level. As shown in FIG. 16, due to EVSS floating, the pixel base voltage EVSS node is opened. As a result, the current path of the driving voltage line (DVL) is blocked. With the current path of the driving voltage line DVL blocked, the pixel driving voltage EVDD may not flow through the driving voltage line DVL. This may prevent burnout in the organic light-emitting diode OLED.

Referring to FIG. 14, during the second period P2, data output floating may be performed. For this, the timing controller 140 may output the data output floating signal DO_FLT to the data driver 120 through the control packet in the EPI communication. That is, the data driving unit 120 may physically or electrically open the reference line RL and data line DL. As shown in FIG. 16, the current path of the reference line RL is blocked. Since the current path of the reference line RL is blocked, the pixel driving voltage EVDD does not flow through the reference line RL. This may prevent burnout in the data driver 120.

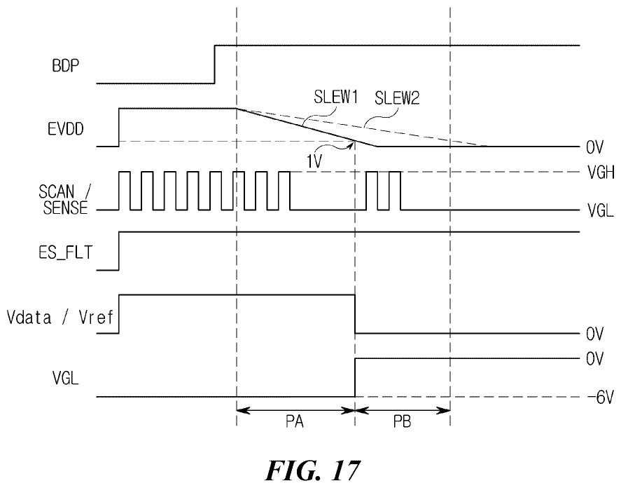

FIG. 17 is a waveform diagram according to the second embodiment of this disclosure;

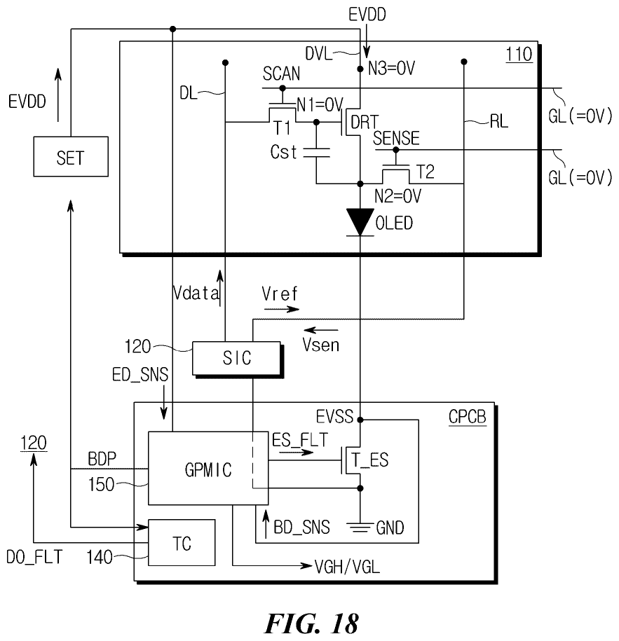

FIG. 18 is a diagram illustrating the operational state of the display apparatus according to the second embodiment of this disclosure;

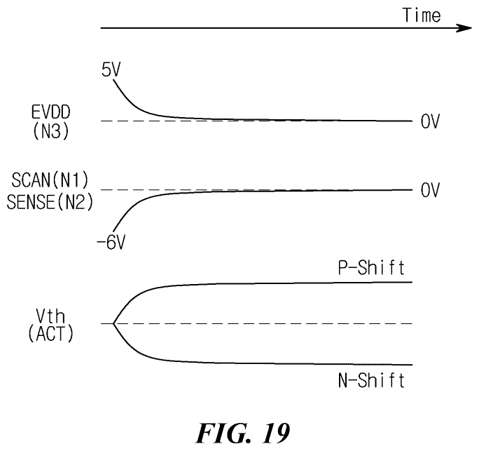

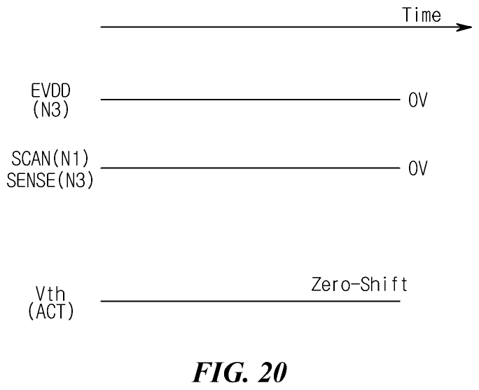

FIG. 19 is a waveform diagram according to a comparative example of this disclosure, and FIG. 20 is a waveform diagram according to the second embodiment.

The first embodiment of the disclosure will be described with reference to FIGS. 17 to 20.

Referring to FIG. 17, the period A PA and the period B PB are shown.

Prior to the period A PA, the BDP signal reaches the turn-on level. As described with reference to FIG. 2, when predetermined conditions are met, it is determined that the operation of the display apparatus 100 is abnormal, and the power driving unit 150 generates the BDP signal. The BDP signal is output to the set system SET and the timing controller 140.

Upon receiving the BDP signal, the set system SET blocks the pixel driving voltage EVDD. As a result, the level of the pixel driving voltage EVDD gradually decreases. When this embodiment is not applied, it is assumed that the level decrease in the pixel driving voltage EVDD due to the natural discharge follows the second discharge rate SLEW2.

According to this disclosure, turn-on discharge is performed during the period A PA. Turn-on discharge may be performed for two frames as an example. However, it is not limited thereto and may be performed for a predetermined number of frames. As a result of turn-on discharge, the display apparatus 100 operates, for the predetermined number of frames, using the data voltage Vdata and reference voltage Vref that displays the image of the last frame. The voltage levels of the data voltage Vdata and reference voltage (Vref) may vary according to the gray scale of the last frame. For example, the data voltage Vdata may be around 5V for a 255 gray image. The voltage level of the data voltage Vdata may differ based on conditions such as average peak luminance (APL) or high dynamic range (HDR). The level decrease of the pixel driving voltage EVDD due to turn-on discharge follows the first discharge rate SLEW1. The first discharge rate SLEW1 has a steeper slope than the second discharge rate SLEW2.

It is defined that the period B PB begins when the voltage level of the pixel driving voltage EVDD decreases by the predetermined amount. The power driving unit 150 may measure the voltage level of the pixel driving voltage EVDD through the EVDD sensing signal ED_SNS.

During period B PB, turn-off discharge is performed. Turn-off discharge may be performed for two frames as an example. However, it is not limited thereto and may be performed for a predetermined number of frames. As a result of the turn-off discharge, the display apparatus 100 may output an image with a 0 gray scale. Accordingly, the voltage levels of the data voltage Vdata and reference voltage Vref may be output as 0V. As shown in FIG. 18, due to being driven by the data voltage Vdata at the 0V level, the voltage level of the first node N1 may become 0V. Additionally, the voltage level of the second node N2 may become 0V due to being driven by a reference voltage Vref at a 0V level.

Furthermore, since the pixel driving voltage EVDD has undergone two discharge cycles (discharge in period A and discharge in period B), the pixel driving voltage EVDD may be completely discharged. Therefore, as shown in FIG. 18, the voltage level of the third node N3 may become 0V. As a comparative example, when only natural discharge or primary discharge in period A is performed, the complete discharge of the pixel driving voltage EVDD may not be achieved, which may result in the voltage level of the third node N3 not being 0V.

During period B PB, zero-level control of the gate low voltage VGL is performed.

The power driving unit 150 typically outputs a gate low voltage VGL at a negative level (e.g., −6V) during normal operation, but through zero-level control, the gate low voltage VGL is boosted to be output as 0V. Referring to FIG. 18, the gate line GL and the first node N1 are adjacent to each other. Additionally, the gate line GL and the second node N2 are also adjacent. In a comparative example where zero-level control of the gate low voltage is not performed, the residual −6V on the gate line GL gradually shifts to 0V over time, causing an issue where inter-line coupling affects the first and second nodes N1 and N2. According to this disclosure, since the residual voltage level on the gate line GL is 0V, the issue of voltage level shifts in the first and second nodes N1 and N2 due to inter-line coupling does not occur.

Referring to the waveforms of the comparative example shown in FIG. 19, in the case where the two discharge cycles according to this disclosure are not performed when the driving of the display apparatus 100 ends, the pixel driving voltage EVDD remains above 0V, and over time, the third node N3, which retains the pixel driving voltage EVDD, naturally discharges from a positive voltage level (e.g., 5V) to 0V. When the zero-level control according to this disclosure is not performed, the first node N1, which retains the scan signal SCAN, and the node that retains the sensing signal SENSE may remain at the negative voltage level of the gate low voltage VGL (e.g., −6V) when the display apparatus 100 is turned off and may naturally discharge to 0V over time. The voltage level change due to the natural discharge of the first node N1, second node N2, and third node N3 causes the trapping or movement of electrons or holes in the active layer ACT of the driving transistor DRT. This causes an issue where the threshold voltage of the driving transistor undergoes a positive shift P-Shift or a negative shift N-Shift. As a result, when the display apparatus or display panel is turned on after being left idle for an extended period, it may lead to poor screen quality.

As shown in FIG. 20, the waveforms according to this disclosure demonstrates that the two discharge cycles during the period A PA and period B PB have brought the third node N3 to 0V. Additionally, during period B PB, the data voltage Vdata and reference voltage Vref at the a 0V level were applied to the first node N1 and second node N2. With the application of the gate low voltage VGL at 0V during period B PB, the voltage level shift of the first node N1 and second node N2, caused by coupling with the gate line GL, was also prevented. As a result, by preventing any influence on the active layer of the drive transistor DRT, the shift in the threshold voltage of the drive transistor DRT is avoided. Therefore, even when the display apparatus or display panel is turned on after being left unused, the screen quality can be well maintained.

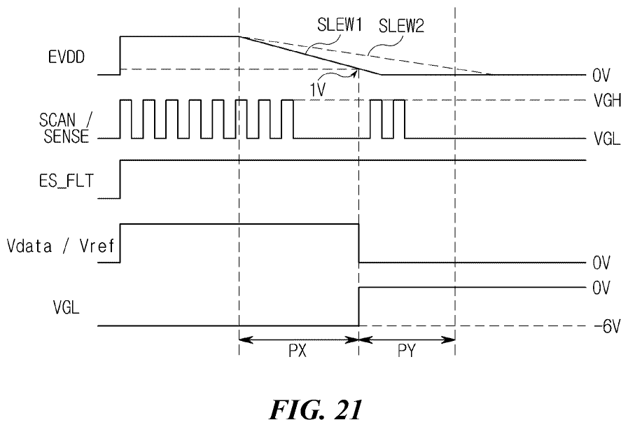

FIG. 21 is a waveform diagram according to a third embodiment of this disclosure.

The embodiment of FIG. 21 differs from the embodiment in FIG. 17 in that the BDP signal is not considered. That is, the third embodiment addresses a scenario where the termination occurs due to normal shutdown, such as a user-initiated power-off, as opposed to an abnormal operation. In describing the third embodiment, explanations identical to those provided above shall be incorporated by reference.

Referring to FIG. 13 and FIG. 21, the period X PX and period Y PY are shown.

When the display apparatus is normally shut down, the set system SET cuts off the pixel driving voltage EVDD. As a result, the voltage level of the pixel driving voltage EVDD gradually decreases.

According to this disclosure, turn-on discharge is performed during the period X PX. Thus, the first discharge rate SLEW1 of the pixel driving voltage EVDD has a steeper slope than the second discharge rate SLEW2 during natural discharge.

Turn-off discharge is performed during the period Y PY. As a result, the voltage level of the first node N1 becomes 0V, and the voltage level of the second node N2 also becomes 0V. Furthermore, the pixel driving voltage EVDD is completely discharged, and the voltage level of the third node N3 also becomes 0V.

Zero-level control of the gate low voltage VGL is performed during the period Y. As a result, the voltage level of the gate line GL becomes 0V, preventing any issues where the voltage levels of the first node N1 and second node N2 shift due to inter-line coupling.

By bringing the voltage levels of the first node N1, second node N2, and third node N3 to 0V, problems such as a negative or positive shift in the threshold voltage of the driving transistor DRT that are caused by long-term idle time are prevented.

According to this disclosure, when the pixel driving voltage is lowered, turn-on discharge, where the image of the last frame is displayed, or turn-off discharge, where an image of 0 gray scale is displayed, is performed. As a result, the discharge of the pixel driving voltage remaining on the driving voltage line may occur faster than natural discharge.

According to this disclosure, when the EVSS transistor is turned off, the EVSS node floats, and the current path of the driving voltage line is blocked. This prevents the pixel driving voltage from passing through the organic light-emitting diode, thereby preventing burnout of the organic light-emitting diode.

According to this disclosure, when the output of the data driving unit floats, the current path of the reference line is blocked. This helps prevent burnout of the components inside the data driving unit.

According to this disclosure, after the pixel driving voltage is lowered to a preset level, the voltage level of the gate low voltage can be output at a zero level instead of the usual negative level. This prevents changes in the active layer state of the driving transistor due to inter-line coupling when the display panel is left idle for a long time. As a result, the threshold voltage shift phenomenon of the driving transistor can be prevented.

The embodiments of the present disclosure have been described with reference to the accompanying drawings. However, the disclosure is not limited to these embodiments. The embodiments can be variously modified within the scope of the technical concept of the disclosure. Accordingly, the embodiments provided herein are for explanatory purposes and are not intended to limit the technical details. The scope of protection of the present disclosure should be interpreted based on the claims in the claims section. Additionally, any technical concepts that fall within the equivalent scope of the claims should be considered as part of the technical concept of the present disclosure.

DESCRIPTION OF REFERENCE NUMERALS

| | |
|---|---|
| 110: display panel | 120: data driving unit |
| 130: gate driving unit | 140: timing controller |
| 150: power driving unit | BDP: BDP signal |
| EVDD: pixel driving voltage | EVSS: pixel base voltage |
| ED_SNS: EVDD sensing signal | BD_SNS: EVSS sensing signal |
| T_ES: EVSS transistor | ES_FLT: EVSS floating signal |
| DO_FLT: data output floating signal | |

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a sub-pixel connected to a driving voltage line, a data line, a reference line, and a gate line, and driven by a pixel driving voltage and a pixel base voltage, the sub-pixel comprising an organic light-emitting diode;
a display panel comprising multiple sub-pixels arranged thereon;
a data driving circuit configured to output a data voltage and a reference voltage to the display panel;
a gate driving circuit configured to output a scan signal and a sensing signal to the display panel;
a timing controller configured to output a plurality of timing control signals;
a power driving circuit configured to output a plurality of voltages including a gate high voltage and a gate low voltage and output a burnt detection and protection (BDP) signal, generated during abnormal driving of the display panel, to the timing controller and an external set system;
an EVSS transistor disposed between a pixel base voltage node and a ground node and controlled by an EVSS floating signal.

2. The display apparatus of claim 1, wherein the EVSS transistor connects an EVSS node and the ground node when turned on, and blocks the connection between the EVSS node and the ground node when turned off.

3. The display apparatus of claim 1, wherein the EVSS transistor is disposed on a control printed circuit board.

4. The display apparatus of claim 1, wherein the power driving circuit receives an EVDD sensing signal configured to sense the pixel driving voltage and an EVSS sensing signal configured to sense the pixel base voltage.

5. The display apparatus of claim 1, wherein the data driving circuit, based on the decrease in the pixel driving voltage, performs at least one of a turn-on discharge configured to output a data voltage and reference voltage for displaying the image of the last frame, and a turn-off discharge configured to output a data voltage and reference voltage for displaying an image with a 0 gray scale.

6. The display apparatus of claim 1, wherein the power driving circuit outputs an EVSS floating signal to control the turn-on and turn-off of the EVSS transistor.

7. The display apparatus of claim 1, wherein the timing controller blocks the output of the gate clock to perform a scan mask.

8. The display apparatus of claim 1, wherein the data driving circuit performs a data output floating to block the output of the data voltage and reference voltage.

9. The display apparatus of claim 8, wherein the timing controller outputs a data output floating signal through a data packet for the data output floating.

10. The display apparatus of claim 1, wherein the power driving circuit performs zero-level control to output a voltage level of the gate low voltage as zero voltage after the turn-off of the display apparatus.

11. The display apparatus of claim 1, further comprising a first period and a second period during which the level of the pixel driving voltage is maintained after the BDP signal is generated.

12. The display apparatus of claim 11, wherein during the first period, the timing controller limits the output of the gate clock, and the driving transistor of the sub-pixel is turned off.

13. The display apparatus of claim 11, wherein during the second period, the EVSS transistor is turned off, and the driving voltage line is opened.

14. The display apparatus of claim 11, wherein during the second period, the data driving circuit blocks the output of the data voltage and reference voltage, and the reference line is opened.

15. The display apparatus of claim 1, further comprising a period A during which the level of the pixel driving voltage decreases after the BDP signal is generated, and a period B during which the pixel driving voltage decreases by a selected voltage level.

16. The display apparatus of claim 15, wherein during the period A, the data driving circuit outputs a data voltage and reference voltage for displaying the image of the last frame, and the pixel driving voltage decreases at a first discharge rate, a slope of which is greater than that of the second discharge rate during natural discharge.

17. The display apparatus of claim 16, wherein the sub-pixel comprises a driving transistor, the third node of which is discharged to 0V.

18. The display apparatus of claim 15, wherein the sub-pixel comprises a driving transistor, and during the period B, the data driving circuit outputs a data voltage and reference voltage for displaying an image with a 0 gray scale, and the first node and second node of the driving transistor are discharged to 0V.

19. The display apparatus of claim 15, wherein during the period B, the power driving circuit outputs the gate low voltage at the zero level.

20. The display apparatus of claim 1, further comprising a period X during which the level of the pixel driving voltage decreases after the display apparatus is turned off, and a period Y during which the pixel driving voltage decreases by a selected voltage level.

21. The display apparatus of claim 20, wherein during the period X, the data driving circuit outputs a data voltage and reference voltage for displaying the image of the last frame, and the pixel driving voltage decreases at the first discharge rate, the slope of which is greater than that of the second discharge rate during natural discharge.

22. The display apparatus of claim 21, wherein the sub-pixel comprises a driving transistor, the third node of which is discharged to 0V.

23. The display apparatus of claim 20, wherein the sub-pixel comprises a driving transistor, and during the period Y, the data driving circuit outputs a data voltage and reference voltage for displaying an image with a 0 gray scale, and the first and second nodes of a driving transistor are discharged to 0V.

24. The display apparatus of claim 20, wherein during the period Y, the power driving unit outputs the gate low voltage at the zero level.
